(19) United States
(12) Patent Application Publication
(10) Pub. No.: US 2005/0035488 A1
(43) Pub. Date: Feb. 17, 2005

(54) Process for obtaining printed matter with embossed highlights

(76) Inventor: Fernando Arturo Caivano, Ciudad de Buenos Aires (AR)

Correspondence Address: Paul L. Brown, Esq.;EMRICH & DITHMAR, Suite 3000, 300 South Wacker Drive, Chicago, IL, 60606, US

(21) Appl. No.: 10/641,273

(22) Filed: Aug. 14, 2003

(51) Int. Cl. B29C 33/40

(52) U.S. Cl. 264/219; 156/219; 156/146

(57) ABSTRACT

A process to obtain printed matter having embossed highlighted parts which consists of first entering data of an image onto a computer. The image is printed on a moldable laminate sheet, and a mold is produced from the selected data. The laminate sheet is molded until the selected data of the image provides an embossment on the sheet. The printed matter obtained by means of the process of the present invention provides a sheet having images that are molded off-set with respect to the plane of the laminated sheet.

### BACKGROUND OF THE INVENTION

The present invention relates to a process for obtaining printed matter with embossed highlighted parts which provides the printing of matter by processing images through a computer from which the necessary data is issued in order to print the images on a moldable laminate sheet and to produce the specific mold for molding the printed laminate sheet.

U.S. Pat. No. 1,604,319 discloses an embossed photo and a method to obtain the photo. The photo is placed between two open-work cardboard sheets with the outline of the selected image and the image is highlighted by means of the application of a special mass.

U.S. Pat. No. 3,772,106 discloses a process to obtain three-dimensional photos. The process consists of an expensive and complex process because several layers of materials are used, such as plywood, rubber foam, aluminum foil, TEFLON sheets, fine cloth, and the like.

U.S. Pat. No. 3,856,592 discloses an embossing method based on the use of a hydraulic press, a mold and a vacuum pump. The embossed photo includes laminate, TEFLON and neoprene layers.

U.S. Pat. No. 4,267,224 discloses a plastic material which simulates embossed metal. It is based on a thermoplastic material and a containment film whereby the embossment may be controlled by means of pressure and heat.

U.S. Pat. No. 4,648,188 discloses a product having three-dimensional images which does not require base materials. By using a photo as a guide, the image is engraved in clay or the like. A forming vacuum machine is used in the process.

U.S. Pat. Nos. 5,763,102 and 6,251,525 refer to three-dimensional cutting methods for solid engravings. Two gypsum masks are required for this process and a concave embossed engraving is obtained.

Most of the known processes are useful to shape molds which are used for the production of several molded units for each mold. However, such processes are not suitable processes to produce a mold for each molded unit, due to costs. In addition, many of the known processes are complex and difficult to operate.

### SUMMARY OF THE INVENTION

The process of the present invention permits the production of a series of different images, each containing its own details, wherein each shaped image is produced with its own mold and at a reasonable cost.

The present invention relates to a process for obtaining printed matter with embossed highlighted parts which consists of a series of steps or stages into which the image data is entered into a computer, and the image is printed on a moldable laminate sheet. In another embodiment, parts of the image are selected and with the selected data, a mold is produced. Utilizing this mold, the laminate sheet is molded until the selected part or portion of the image is uneven or embossed. The invention also relates to printed matter obtained by a process in which a part or portion of the images on a laminate sheet are molded uneven or embossed.

One advantage of the process is its simplicity. The process is based on image processing by means of a computer wherein the data may be used to make a mold or the data may be used to print the image on the sheet which will be shaped later.

Another advantage of the present invention is that the process does not require large facilities because only a few easily available means are used.

A still further advantage of the present invention is that the process is applicable to different types of laminate sheets, such as plastic or paper, with or without emulsions.

Also, the present invention describes a process wherein different devices and means may be used in association with the mold manufacturing stage or in association with the graphic printing stage. For example, different types of printers, including ink-jet, laser, sublimation, and thermal transfer may be used during the graphic printing stage, and different devices, such as the device described in U.S. Pat. No. 5,921,012 may be used in the mold manufacturing stage.

### DESCRIPTION OF THE DRAWINGS

For the purpose of facilitating and understanding the present invention, it is illustrated in the accompanying drawings the preferred embodiment of the present invention hereof, from an inspection of which, when considered in connection with the following description, the invention, its operation, and many of its advantages, will be readily understood and appreciated.

FIGS. 1A-1H are perspective views of the method and the process for obtaining printed matter with embossed portions on laminate sheets in accordance with the present invention;

FIGS. 2A-2B are perspective views of the several types of embossed portions positioned on the laminate sheets in accordance with the present invention;

FIG. 3 is a sectional view taken along one embodiment of an embossed portion on a laminate sheet in accordance with one embodiment of the present invention;

FIGS. 4A-4C are cross-sectional views illustrating the application of a background sheet to the embossed portion in accordance with the present invention.

FIGS. 5A-5C are cross-sectional views illustrating the application of a filling material into the embossment cavity in accordance with the present invention; and

FIGS. 6A-6B are cross-sectional views illustrating the application of a protective sheet in accordance with the present invention.

### REFERENCE NUMERALS IN DRAWINGS

(1) Data entry devices;
(2) Digital camera;
(3) Scanner;
(4) Diskette drive;
(5) CD unit;
(6) Compact disk;
(7) Diskette;
(8) Computer;
(9) Monitor;
(10) Basic image;
(11) Selected part of the image 10;
(12) Shape or outline of the selected image 11;
(13) Mold producer device 16;
(14) Cutting member of the device 13;
(15) Plate members for molds 16;
(16) Mold;
(17) Printer (graphic printing device-output);
(18) Laminate sheet;
(19) Heater member or means;
(20) Molding base;
(21) Embossment;
(22) Background sheet;
(23) Embossment cavity (formed by the embossment 21 between the laminate sheet 18 and the background sheet 22);
(24) Filling of the embossment cavity 23;
(25) Recto face of the laminate sheet 18;
(26) Verso face or surface of the laminate sheet 18;
(27) Protection layer.

### DESCRIPTION OF THE EMBODIMENTS

In general, the present invention relates to a process for obtaining printed matter with embossed highlighted parts which comprise a series of stages or steps in which first the data from an image 10 is entered into a computer 8 and then the image 10 is printed onto a moldable laminate sheet 18. In the alternative, parts or portions 11 of the image 10 may be selected, and a mold 16 is produced utilizing the selected data. The mold 16 and the laminated sheet 18 are molded until the selected part or portion 11 of the images is uneven or has an embossment 21.

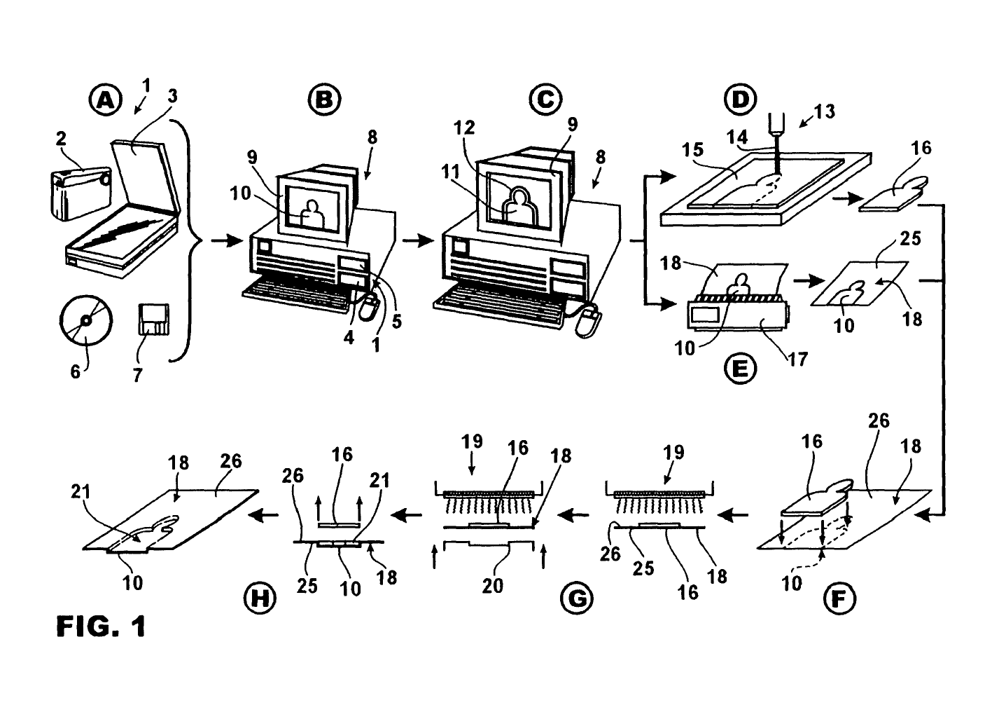

As shown in FIGS. 1A and 1B, the process may include a first stage or step wherein the data corresponding to an image 10 is entered into the computer 8. This can be done through data input devices 1, such as, a digital camera 2 or a film camera. The data input may also be performed from graphic reproductions such as photos, drawings or graphic printed matter, which data may be obtained through input devices, such as a scanner 3. Also, data obtained by other systems may be entered through internal or external networks. For example, data contained in compact disks 6, D.V.D's or diskettes 7 may be entered into the computer 8 by means of a compact disk unit 5 or a diskette drive 4, respectively, as is known in the art.

As shown in FIG. 1C, once the data which corresponds to the basic image 10 to be processed has been entered into the computer 8, the above mentioned basic image is visualized or displayed on the monitor screen 9, and a part or portion 11 of the image is selected.

In one embodiment of the present invention, the data which corresponds to the shape 12 of the selected portion 11 is forwarded to an output for its application onto a mold producer member. In this output, there may either be a printer 17 which printing is useful for manual production of the mold 16 or there may be a mold producer device 13, as shown in FIG. 1D.

A mold producer device or member 13 suitable for use in the present invention is a cutting pantograph, for example, of a router type, although other mold producer devices 13 might be used, in which the cutting member 14 could be, for example, a laser or an electric resistance device.

The cutting member 14 works on plate members 15 that may be made of metal, wood or plastic. In the case of plastic plates 15, the plates may be obtained from a plastic mass laminated to a thickness predetermined by the height of the unevenness or embossment 21 to be molded. With this process, which is useful to print embossments 21 on laminated sheets 18, a mold having the shape 12 of the selected part 11 is produced.

In another embodiment of the present invention, data which corresponds to the basic image 10 entered in the computer 8 is forwarded to a graphic printing device, such as a printer 17. Thereafter, the graphic printing of the basic image 10 is deposited on a moldable laminate sheet 18 by the embossment 21, as shown in FIG. 1E.

As shown in FIG. 1F, this laminate sheet 18 containing the basic image or images 10 is submitted to molding, using the produced mold for this operation. For this purpose, a complementary base 20 of the above mentioned mold 16 may be positioned and aligned to be superimposed onto the image 10, as shown in FIG. 1G.

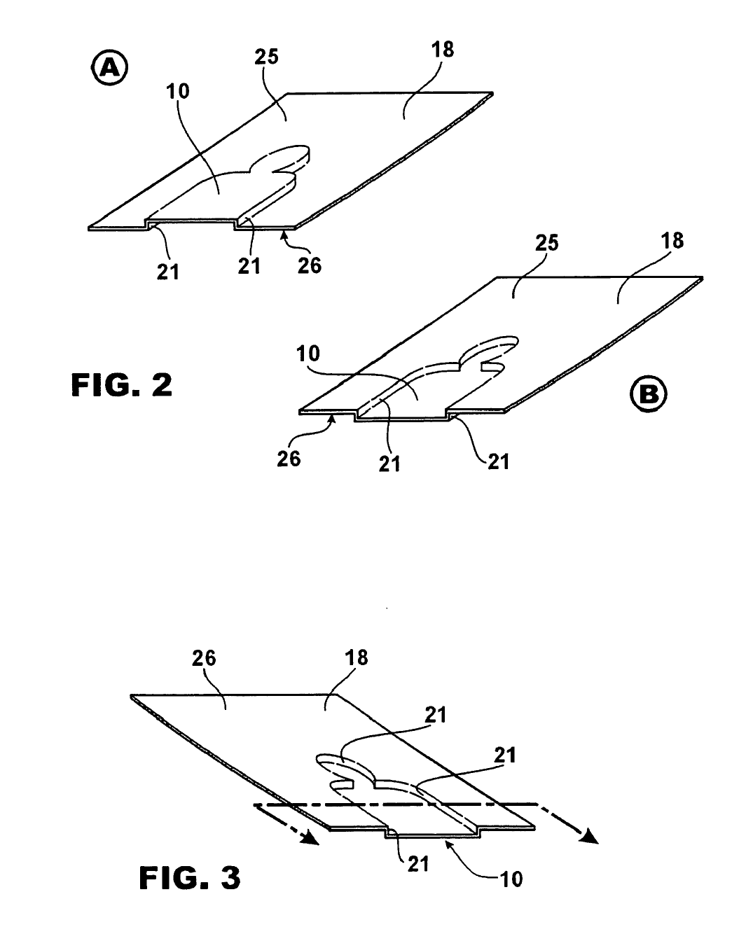

In the present invention, the molding operation is carried out by placing the laminate sheet 18 under the influence of a heater member 19 which facilitates its molding, as shown in FIG. 1G. Once molding has been completed, as shown FIG. 1H, the selected part of the image 11 is left uneven with respect to the remainder of the laminate sheet 18. In one embodiment of the invention, the molding is performed so that this unevenness consists of a protruding embossment 21 with respect to the recto or front face 25 of the laminate sheet 18, as shown in FIG. 2A. In another embodiment, the molding is carried out so that the unevenness consists of a re-entrant embossment which defines a cavity or depression with respect to the above mentioned recto face 25 of the laminate sheet 18, as shown in FIG. 2B. There in another embodiment wherein the unevenness consists of a mixed embossment 21 with protruding and re-entrant areas with respect to the remainder or planar surface of the recto face 25 of the laminate sheet 18.

In order to obtain the different variants, the mold 16 and the base 20 are arranged, either arranging the mold 16 between the heater member 19 and the laminate sheet 18 as a screen, or by arranging the mold 16 behind the above mentioned laminate sheet 18 with respect to the heater member 19.

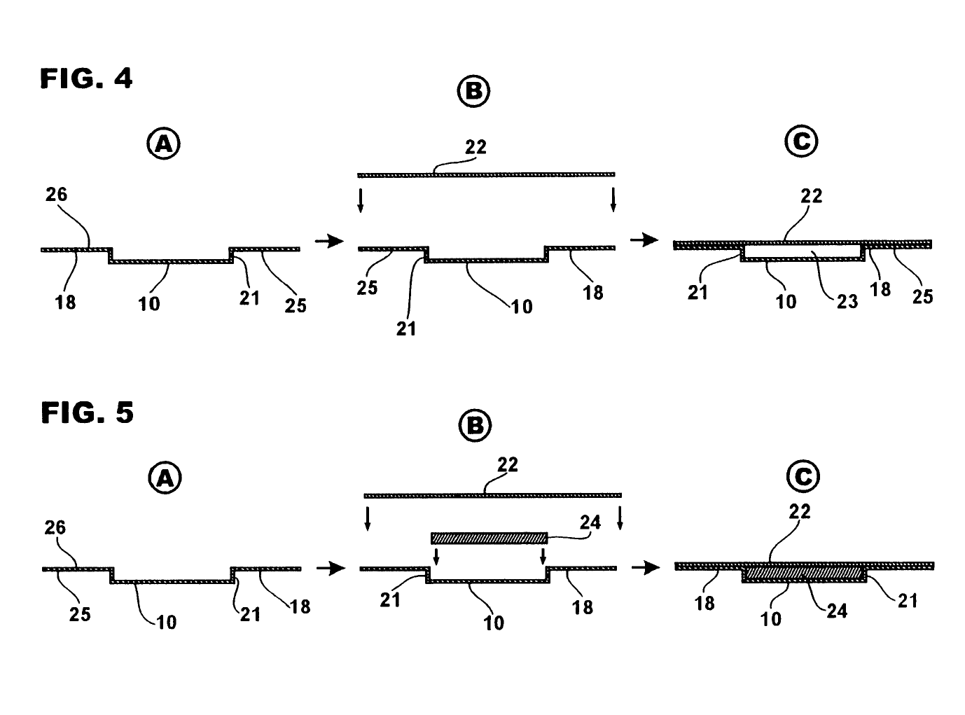

After being molded, the laminate sheet 18 may remain as it is, or pass through another operation in which a background sheet 22 is fixed, as shown in FIGS. 4A and 4B. This background sheet 22 may be fixed by means of the application of an adhesive glue or may be welded by welding means.

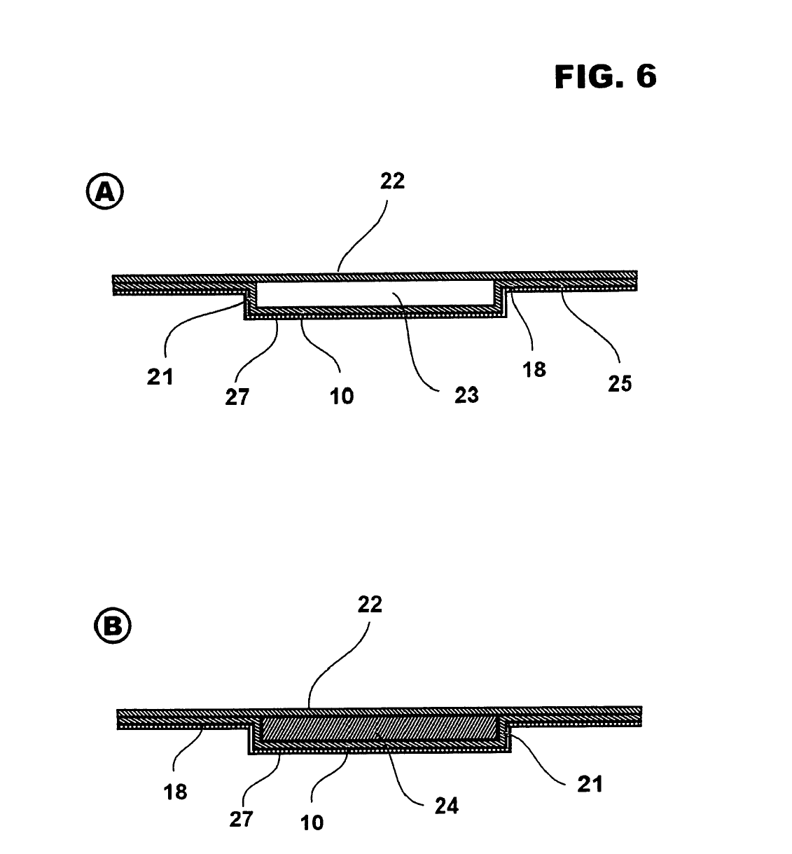

The eventual application of a protection cover or layer member 27 has also been provided on the recto face 25 of the laminate sheet 18, as shown in FIG. 6A. In this operation, an embossment cavity 23 is formed between the embossment 21 of the laminate sheet 18 and the wall of the background sheet 22, as shown in FIG. 4C.

In another embodiment, as shown in FIGS. 5A-5C and also in FIG. 6B, the cavity 23 may be filled. For this purpose, after molding the laminate sheet 18 and before fixing the background sheet 22 to the verso or back surface 26, a filling material 24 is interposed between both sheets so that the material remains lodged within cavity 23 of the embossment 21. This filling material 24 may consist of different materials suitable for this effect and may include the mold material.

In still another embodiment of the invention, prior to the fixation of the background sheet 22, a magnetic member may be provided in the embossment cavity 23 which then is useful to adhere or mount the entire set to metal surfaces. Also in a further embodiment of the present invention, prior to the fixation of the background sheet 22, a lighting member may be provided in the embossment cavity 23 to provide a decorative effect.

In yet another embodiment, prior to the fixation of the background sheet 22, a filling material 24 may be provided in the embossment cavity 23 and consist of a liquid providing a decoration effect. This is effective when the laminate sheet is transparent or translucent.

The printed matter obtained through the process of the present invention consists of a laminate sheet 18 on which the recto face 25 contains images 10. A selected portion 11 of these images 10 may be molded as uneven, off-set or with an embossment 21, as shown in FIGS. 1H, 4A and 5A. The embossment 21 may be protruding or a cavity depression with respect to the planar surface of the laminate sheet 18. The verso or opposite face 26 is flat due to the presence of a background sheet 22, as shown in FIGS. 4C, 5C, 6A and 6B.

As set forth in one embodiment, the cavity 23 defined by the protruding embossment 21 contains filling material 24 which contributes to a more compact set, as shown in FIGS. 5C and 6B. In the case of the protruding embossment cavity 23, the filling material 24 is structurally arranged between sheets 18 and 22 in the above mentioned embossment cavity 23.

As pointed out above, in the various embodiments, the printed matter may include magnetic means for the fixation to metal surfaces and lighting means or filling liquids 24 to provide a decorative or ornamental effect in its embossment cavity 23.

It is also within the scope of the present invention that the various embodiments may include holes, rings or any other hanging members as well as support legs to maintain and support the invention on any horizontal surface.

1. A process for obtaining printed matter having embossed highlighted portions on a substrate material utilizing a computer operatively connected to data input and output devices and a mold producing member, includes the steps of:
entering the data corresponding to a basic image to be processed into a computer by means of a data input device;
visualizing the entered basic image,
selecting at least a portion of said basic image and generating the data which correspond to the outline of the selected image portion;
forwarding the data of the outline of the selected image portion to an output for application to a mold producer member;
producing a mold from the outline of said selected image portion by means of said mold producer member by graphic printing an embossment defined by the outline onto a laminate sheet; and
molding said laminate sheet containing said selected image portion thereon wherein said selected molded image portion is off-set with respect to the substantially planar surface of said laminate sheet.

2. The process for obtaining printed matter in accordance with claim 1, wherein prior to the step of entering the data corresponding to a basic image into the computer, the step of generating a basic digitized image is obtained for entering into the computer.

3. The process for obtaining printed matter in accordance with claim 1, wherein after the step of molding said laminate sheet includes the step of fixing the verso face of said laminate sheet onto a background sheet.

4. The process for obtaining printed matter in accordance with claim 1, wherein said molded off-set of said selected image portion consists of a protruding embossment with respect to the substantially planar surface of said laminate sheet.

5. The process for obtaining printed matter in accordance with claim 1, wherein the molded off-set is a concave embossment with respect to the substantially planar surface of said laminate sheet.

6. The process for obtaining printed matter in accordance with claim 1, wherein the molded off-set includes a combination of a protruding embossment and a concave embossment with respect to the substantially planar surface of said laminate sheet.

7. The process for obtaining printed matter in accordance with claim 1, wherein said output of said step of forwarding the data of the outline of the selected element is operatively connected to a mold producer device.

8. The process for obtaining printed matter in accordance with claim 1, wherein said output of said step of forwarding the data of the outline of the selected element corresponds to a printer in which printing is structurally arranged for the manual production of molds.

9. The process for obtaining printed matter in accordance with claim 7, wherein said mold producer device is a cutting pantograph.

10. The process for obtaining printed matter in accordance with claim 9, wherein said cutting pantograph is of the router type.

11. The process for obtaining printed matter in accordance with claim 1, wherein the material for mold production is selected from a group consisting of metal plates, wooden plates, plastic plates, and plates made of cellulosic material.

12. The process for obtaining printed matter in accordance with claim 1, wherein the material for mold production consists of plastic plates obtained from a plastic mass conforming to a thickness predetermined by the height of the molded off-set.

13. The process for obtaining printed matter in accordance with claim 3, wherein after the step of molding said laminate sheet and prior to fixing said background sheet to the verso face of said laminate sheet, a filling material is inserted between said sheets.

14. The process for obtaining printed matter in accordance with claim 13, wherein said filling material consists of the mold material.

15. The process for obtaining printed matter in accordance with claim 3, wherein after the step of molding said laminate sheet and prior to fixing said background sheet to the verso face of said laminate sheet, a magnetic member is positioned within the cavity formed by the embossment.

16. The process for obtaining printed matter in accordance with claim 3, wherein after the step of molding said laminate sheet to molding and prior to fixing said background sheet to the verso face of said laminate sheet, a lighting member is positioned within the cavity formed by the embossment.

17. The process for obtaining printed matter in accordance with claim 13, wherein a portion of said laminate sheet is transparent and the filling material comprises a liquid providing a decorative effect.

18. The process for obtaining printed matter in accordance with claim 1, wherein subsequent to said step of molding said laminate sheet containing said selected image includes the step of covering the recto face of said laminate sheet with a protection layer.

19. The process for obtaining printed matter in accordance with claim 1, wherein said selected image portion on said recto face of said laminate sheet is molded to be off-set with respect to the planar surface of said laminate sheet.

20. The printed matter in accordance with claim 19, wherein said embossed molded part is at least one of a protruding embossment, a concave embossment or a mixture thereof.

21. The printed matter in accordance with claim 20, wherein said embossed molded images on said verso face of said laminate sheet provides said concave embossment conforming to the height of said molded images.

22. The printed matter in accordance with claim 21, wherein the concave embossment contains filing material.

23. The printed matter in accordance with claim 21, wherein said concave embossment contains decorative means.

24. The printed matter in accordance with claim 19, wherein said molded image includes a hanging member.

25. The printed matter in accordance with claim 19, wherein said molded image includes a support leg.

26. A process for obtaining printed matter having embossed highlighted portions on a substrate material utilizing a computer operatively connected to data input and output devices and a mold producing member, including the steps of:
entering the data corresponding to a basic image to be processed into a computer by means of a data input device;
visualizing the entered basic image,
selecting at least a portion of said basic image and generating the data which correspond to the outline of the selected image portion;
forwarding the data of the outline of the selected image portion to an output for application to a graphic printing device;
producing a mold from the outline of said selected image portion by means of said graphic printing device by printing an embossment defined by the outline onto a laminate sheet; and
molding said laminate sheet containing said selected image portion thereon wherein said selected molded image portion is off-set with respect to the substantially planar surface of said laminate sheet.

27. The process for obtaining printed matter in accordance with claim 26, wherein prior to the step of entering the data corresponding to a basic image into the computer, the step of generating a basic digitized image is obtained for entering into the computer.

28. The process for obtaining printed matter in accordance with claim 26, wherein after the step of molding said laminate sheet includes the step of fixing the verso face of said laminate sheet onto a background sheet.

29. The process for obtaining printed matter in accordance with claim 26, wherein said molded off-set of said selected image portion consists of a protruding embossment with respect to the substantially planar surface of said laminate sheet.

30. The process for obtaining printed matter in accordance with claim 26, wherein the molded off-set is a concave embossment with respect to the substantially planar surface of said laminate sheet.

31. The process for obtaining printed matter in accordance with claim 26, wherein the molded off-set includes a combination of a protruding embossment and a concave embossment with respect to the substantially planar surface of said laminate sheet.
